(19) United States
(12) Patent Application Publication
(10) Pub. No.: US 2024/0191048 A1
(43) Pub. Date: Jun. 13, 2024

(54) ANTI-REFLECTANCE FILM AND DISPLAY DEVICE

(71) Applicant: Shenzhen China Star Optoelectronics Semiconductor Display Technology Co., Ltd., Shenzhen (CN)

(72) Inventor: Chanjuan LIU, Shenzhen (CN)

(73) Assignee: Shenzhen China Star Optoelectronics Semiconductor Display Technology Co., Ltd., Shenzhen (CN)

(21) Appl. No.: 18/089,616

(22) Filed: Dec. 28, 2022

(30) Foreign Application Priority Data
Dec. 13, 2022 (CN) 202211601333.0

(51) Int. Cl. C08J 7/04; C08J 9/00; C09D 133/06; C09D 133/08; G02B 1/111

(52) U.S. Cl. CPC C08J 7/0423; C08J 9/008; C09D 133/062; C09D 133/08; G02B 1/111; C08J 2333/08

(57) ABSTRACT

The present application provides an anti-reflectance film and a display device. The display device includes a display panel and the anti-reflectance film located on a light-emitting side of the display panel. The anti-reflectance film includes a substrate, a transition layer, and an anti-reflectance layer. The transition layer is located on a side of the substrate. The anti-reflectance layer is located on a side of the transition layer away from the substrate. A refractive index of the transition layer is greater than a refractive index of the substrate.

### RELATED APPLICATION

This application claims the benefit of priority of Chinese Patent Application No. 202211601333.0 filed on Dec. 13, 2022, the contents of which are incorporated herein by reference in their entirety.

### TECHNICAL FIELD

The present application relates to a field of display technologies, and specifically relates to an anti-reflectance film and a display device.

### BACKGROUND

With a rapid development of electronic products such as computers and cameras, people's demands for reducing reflected light are constantly increasing. As an important optical film, an anti-reflectance film may effectively reduce the reflected light on a surface of the anti-reflectance film by an interference cancellation effect, so the anti-reflectance film has a wide range of application scenarios.

As a coating film, the anti-reflectance film may be coated on a light-emitting side of a display device. As shown in FIG. 1, FIG. 1 is a schematic structural diagram of an existing display module. The existing display module 1 includes a display panel 10 and a conventional anti-reflectance film 20 located on a light-emitting side of the display panel 10. The conventional anti-reflectance film 20 includes a substrate 21 and an anti-reflectance (AR) layer 22A disposed on the display panel 10 in sequence. The conventional anti-reflectance film 20 is configured to reduce the reflected light on the light-emitting side of the display panel 10 by the interference cancellation effect, thereby increasing light transmittance of the display panel 10 and improving display quality of screens. However, a refractive index of a material of the anti-reflectance layer 22A is generally required particularly lower to achieve a better antireflection effect, so process requirements of manufacturing the anti-reflectance layer 22A are required to be higher. In addition, the refractive index of the material of the anti-reflectance layer 22A is lower, and mechanical properties of the anti-reflectance layer 22A are worse, thereby reducing stability and reliability of the conventional anti-reflectance film 20.

### SUMMARY

An anti-reflectance film and a display device are provided by the present application to alleviate deficiencies in related technologies.

To realize above functions, technical solutions provided by embodiments of the present application are as follows.

The present application provides an anti-reflectance film, including:
a substrate;
a transition layer located on a side of the substrate; and
an anti-reflectance layer located on a side of the transition layer away from the substrate;
wherein a refractive index of the transition layer is greater than a refractive index of the substrate.

In the anti-reflectance film provided by an embodiment of the present application, a refractive index of the anti-reflectance layer and the refractive index of the transition layer satisfy a following relationship:

n₁²=n₀×n₂;
wherein, n₀ denotes a refractive index of an external medium located on a side of the anti-reflectance layer away from the transition layer, n₁ denotes the refractive index of the anti-reflectance layer, and n₂ denotes the refractive index of the transition layer.

In the anti-reflectance film provided by an embodiment of the present application, the refractive index of the transition layer is greater than or equal to 1.56, and less than or equal to 1.65, and the refractive index of the anti-reflectance layer is greater than or equal to 1.25, and less than or equal to 1.28.

In the anti-reflectance film provided by an embodiment of the present application, a thickness of the transition layer and the refractive index of the transition layer satisfy a following relationship:

$${D}_{1} = \frac{( m + 1 / 2 )}{\begin{matrix}( λ / 2 ) & {n}_{2}\end{matrix}} ;$$

wherein, n₂ denotes the refractive index of the transition layer, λ is a wavelength of light, m is a natural number, and D1 denotes the thickness of the transition layer.

In the anti-reflectance film provided by an embodiment of the present application, the thickness of the transition layer is greater than or equal to 30 μm, and less than or equal to 110 μm.

In the anti-reflectance film provided by an embodiment of the present application, the transition layer includes following components in parts by weight: 40-70 parts of photopolymerization resin, 0-30 parts of photopolymerization monomer, 1-10 parts of photoinitiator, 5-30 parts of nano oxide dispersion, 900-9900 parts of solvent, and 0.1-1 part of other auxiliaries.

In the anti-reflectance film provided by an embodiment of the present application, a functionality of the photopolymerized resin is greater than or equal to 5, and the photopolymerized resin includes one of polyester acrylic resin, polyurethane acrylic resin, epoxy acrylic resin, and polysilsesquioxane or a plurality of combinations thereof.

In the anti-reflectance film provided by an embodiment of the present application, a glass transition temperature of the photopolymerization monomer is greater than or equal to 85 degrees Celsius.

In the anti-reflectance film provided by an embodiment of the present application, the photopolymerization monomer includes a ring structure, the photopolymerization monomer includes one or combinations of isobornyl acrylate, isobornyl methacrylate, and tricyclodecane dimethanol diacrylate.

In the anti-reflectance film provided by an embodiment of the present application, the nano oxide dispersion includes a plurality of nano-particles, the nano-particles include, but are not limited to, one or combinations of antimony pentoxide, zirconia, zinc oxide, titanium oxide, cerium oxide, and iridium oxide, and a particle size of each of the plurality of nano-particles is greater than or equal to 5 nm, and less than or equal to 25 nm.

The present application provides a display device, including a display panel and the anti-reflectance film above-mentioned, the anti-reflectance film is located on a light-emitting side of the display panel.

Beneficial effects of the embodiment of the present application: The embodiments of the present application provide the anti-reflectance film and the display device. The display device includes the display panel and the anti-reflectance film located on the light-emitting side of the display panel. The anti-reflectance film may prevent total reflection of ambient light on the display panel, thereby reducing reflectivity of the display panel. The anti-reflectance film includes the substrate, the transition layer, and the anti-reflectance layer. The transition layer is located on the side of the substrate. The anti-reflectance layer is located on the side of the transition layer away from the substrate. The refractive index of the transition layer is greater than the refractive index of the substrate. Compare with a conventional anti-reflectance film, in the embodiments of the present application, the refractive index of the transition layer is greater than the refractive index of the substrate, so that the anti-reflectance layer has higher refractive index, thereby reducing process difficulties of manufacturing the anti-reflectance layer in the embodiments of the present application, improving mechanical properties of a surface of the anti-reflectance layer, and improving display effects of the display panel without affecting other performances of the display panel at a same time.

### DESCRIPTION OF DRAWINGS

To describe technical solutions of embodiments of the present application more clearly, the following briefly introduces accompanying drawings used in a description of the embodiments of the present disclosure. Apparently, the accompanying drawings described below illustrate only some exemplary embodiments of the present application, and persons skilled in the art may derive other drawings from the drawings without making creative efforts.

FIG. 1 is a schematic structural diagram of an existing display module.

FIG. 2 is a schematic structural diagram of an anti-reflectance film by a first embodiment of the present application.

FIG. 3 is a curve diagram of reflectivity of the anti-reflectance film provided by the first embodiment of the present application under different wavelengths of light.

FIG. 4 is a curve diagram of reflectivity of an anti-reflectance film provided by a second embodiment of the present application under different wavelengths of the light.

FIG. 5 is a curve diagram of reflectivity of an anti-reflectance film provided by a third embodiment of the present application under different wavelengths of the light.

FIG. 6 is a curve diagram of reflectivity of an anti-reflectance film provided by a first comparative embodiment of the present application under different wavelengths of the light.

### DETAILED DESCRIPTION OF EMBODIMENTS

The technical solutions in embodiments of the present application will be described clearly and completely hereafter with reference to the accompanying drawings. Apparently, described embodiments are only a part of but not all embodiments of the present application. All other embodiments obtained by persons of ordinary skill in the art based on the embodiments of the present disclosure without creative efforts shall fall within a protection scope of the present application. In addition, it should be understood that specific embodiments described herein are merely for explaining the present application, the term “embodiment” used in a context means an example, instance, or illustration, and the present application is not limited thereto. In the present application, location terms such as “up” and “down” are used in general to refer to up and down in actual use or operation of a device, in particular drawing directions in the drawings, without description to the contrary. While “inside” and “outside” are for the outline of the device.

An anti-reflectance film and a display device are provided by embodiments of the present application. Detailed descriptions are explained below. It should be noted that, a description order of following embodiments is not used to define a preferred order of the embodiments.

Referring to FIG. 2 to FIG. 5, the anti-reflectance film and the display device are provided by embodiments of the present application. The anti-reflectance film 20B includes a substrate 21, a transition layer 23, and an anti-reflectance layer 22. The transition layer 23 is located on a side of the substrate 21. The anti-reflectance layer 22 is located on a side of the transition layer 23 away from the substrate 21. A refractive index n₂ of the transition layer 23 is greater than a refractive index n₃ of the substrate 21.

It should be noted that the embodiments of the present application provide the anti-reflectance film 20B, and the anti-reflectance film 20B further includes the transition layer 23 located between the substrate 21 and the anti-reflectance layer 22. The refractive index n₂ of the transition layer 23 is greater than the refractive index n₃ of the substrate 21. Compare with a conventional anti-reflectance film 20, the anti-reflectance layer 22 provided by the embodiments of the present application has a higher refractive index, thereby reducing process difficulties of manufacturing the anti-reflectance layer 22 in the embodiments of the present application, improving mechanical properties of a surface of the anti-reflectance layer 22, and improving display effects of the display 10 without affecting other performances of the display panel 10 at a same time.

The technical solutions of the present application are described in combination with specific embodiments.

### Embodiment 1

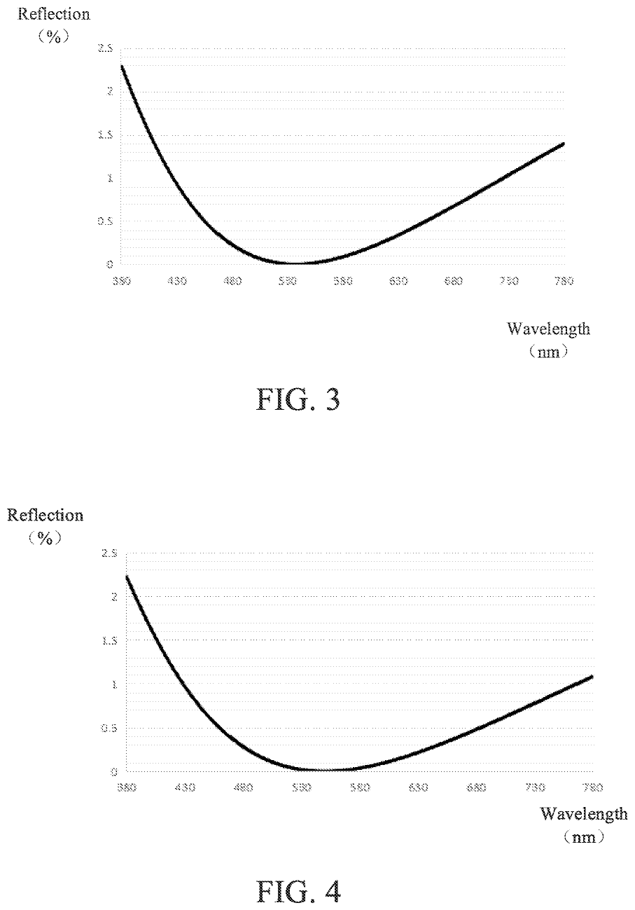

Incorporating FIG. 2 and FIG. 3, FIG. 2 is a schematic structural diagram of an anti-reflectance film in the embodiment 1 of the present application. FIG. 3 is a curve diagram of reflectivity of the anti-reflectance film provided by the embodiment 1 of the present application under different wavelengths of light.

The present application provides the anti-reflectance film 20B, the anti-reflectance film 20B may be configured to reduce reflected light on a light-emitting side of the display panel. The anti-reflectance film 20B includes the substrate 21, the transition layer 23, and the anti-reflectance layer 22. The transition layer 23 is located on the side of the substrate 21. The anti-reflectance layer 22 is located on the side of the transition layer 23 away from the substrate 21. A material of the substrate 21 may select a film material having good mechanical strength and light transmittance. The material of the substrate 21 includes, but is not limited to, resin film materials such as Polymethyl methacrylate (PMMA), Polyethylene terephthalate (PET), Polynaphthalene dicarboxylate (PEN), Polycarbonate (PC), Triacetyl cellulose (TAC), Polyimide (PI), Polyethylene (PE), Polypropylene (PP), Polyvinyl alcohol (PVA), Polyvinyl chloride (PVC), and Cycloolefin copolymer (COC).

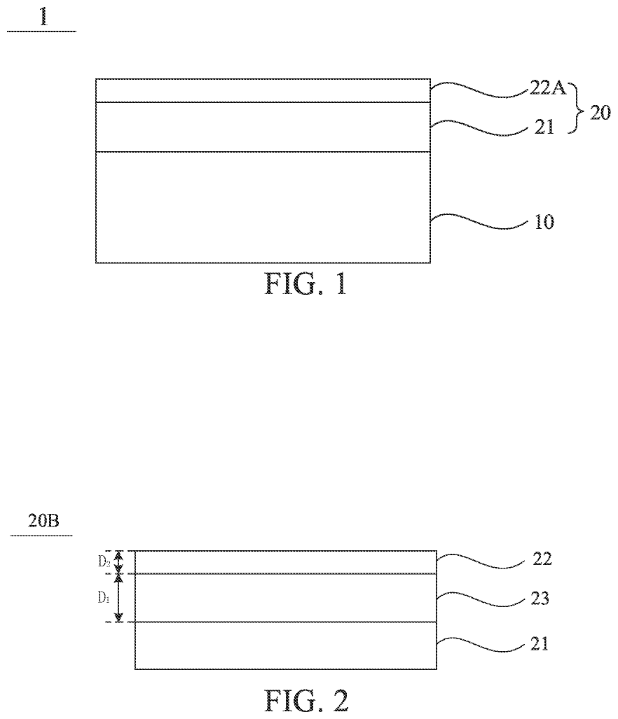

It should be noted that combine FIG. 1, in an existing display module, the conventional anti-reflectance film 20 may reduce the reflected light on the light-emitting side of the display panel 10 by an interference cancellation effect. A refractive index of an anti-reflectance layer 22A of the conventional anti-reflectance film 20 is generally 1.22, so materials available for the anti-reflectance layer 22A are limited, and process requirements of manufacturing the anti-reflectance layer 22A are required to be higher. In addition, a refractive index of the material of the anti-reflectance layer 22A of the conventional anti-reflectance film 20 is lower, and mechanical properties of the anti-reflectance layer 22A are worse, thereby reducing stability and reliability of the conventional anti-reflectance film 20.

In this embodiment, the anti-reflectance film 20B further includes the transition layer 23 located between the substrate 21 and the anti-reflectance layer 22, and the refractive index n₂ of the transition layer 23 is greater than the refractive index n₃ of the substrate 21.

Specifically, in this embodiment, in order to achieve an optimal antireflection effect, a refractive index of the anti-reflectance layer 22 and the refractive index of the transition layer 23 satisfy a following relationship:

n₁²=n₀×n₂ (1)
wherein, n₀ denotes a refractive index of an external medium located on a side of the anti-reflectance layer 22 away from the transition layer 23, n₁ denotes the refractive index of the anti-reflectance layer 22, and n₂ denotes the refractive index of the transition layer 23.

It should be noted that the embodiment takes the external medium located on the side of the anti-reflectance layer 22 away from the transition layer 23 as air for example. Furthermore, the refractive index n₂ of the transition layer 23 is greater than or equal to 1.56, and less than or equal to 1.65. The refractive index n of the anti-reflectance layer 22 is greater than or equal to 1.25, and less than or equal to 1.28. For example, the refractive index n₂ of the transition layer 23 is 1.56, 1.59, or 1.65.

It may be understood that the refractive index n₀ of the air is approximately equal to 1. The refractive index n₂ of the transition layer 23 is greater than or equal to 1.56, and less than or equal to 1.65. The refractive index n of the anti-reflectance layer 22 is equal to a square root of the refractive index n₂ of the transition layer 23. The refractive index n₁ of the anti-reflectance layer 22 is greater than or equal to 1.25, and less than or equal to 1.28. Therefore, compared with the conventional anti-reflectance film 20, the refractive index of the conventional anti-reflectance film 20 is generally 1.22, the anti-reflectance layer 22 provided by the embodiment of the present application has higher refractive index, thereby reducing the process difficulties of manufacturing the anti-reflectance layer 22 in the embodiments of the present application, improving the mechanical properties of the surface of the anti-reflectance layer 22, and improving the display effects of the display panel 10 without affecting other performances of the display panel 10 at the same time.

Furthermore, in this embodiment, a thickness of the transition layer 23 and the refractive index of the transition layer 23 satisfy a following relationship:

$${D}_{1} = \frac{( m + 1 / 2 )}{\begin{matrix}( λ / 2 ) & {n}_{2}\end{matrix}} \qquad ( 2 )$$

wherein, n₂ denotes the refractive index of the transition layer 23, λ is a wavelength of the light, m is a natural number, and D1 denotes the thickness of the transition layer 23.

The thickness D1 of the transition layer 23 is greater than or equal to 30 μm, and less than or equal to 110 μm. In an embodiment, the thickness D1 of the transition layer 23 is 50 μm, 80 μm, or 110 μm.

It may be understood that in a prior art, the conventional anti-reflectance film 20 includes a substrate 21 and the anti-reflectance layer 22A disposed on the display panel 10 in sequence. In this embodiment, the anti-reflectance film 20B includes the substrate 21, the transition layer 23, and the anti-reflectance layer 22. Through a mutual cooperation between the transition layer 23 and the anti-reflectance layer 22, the transition layer 23 and the anti-reflectance layer 22 may be respectively provided with corresponding thicknesses, and the refractive index n₂ of the transition layer 23 has a wider selectable range. Therefore, the anti-reflectance film 20B provided by the embodiment has more freedom of combination in design, so that the anti-reflectance film 20B has low reflectivity in a wide spectral range. Furthermore, the thickness D1 of the transition layer 23 is 50 μm, 80 μm, or 110 μm, so the thickness of the transition layer 23 does not need to be precisely controlled at a nanometer level, and thus process of manufacturing the transition layer 23 are relatively simple and a process cost is lower, thereby improving production efficiency.

It should be noted that in this embodiment, the technical solutions of the present application are illustrated by taking following conditions as examples: The refractive index n₃ of the substrate 21 is 1.49, the material of the substrate 21 is Triacetyl cellulose (TAC), the refractive index n₂ of the transition layer 23 is 1.65, the thickness D1 of the transition layer 23 is 30 μm, the refractive index n₁ of the anti-reflectance layer 22 is 1.28, a thickness D2 of the anti-reflectance layer 22 is 107 nm, and a material of the anti-reflectance layer 22 is silicon dioxide (SiO₂) of hollow particles. Furthermore, In this embodiment, under the conditions that the wavelength of the light λ is 550 nm, an optical film design software is used for simulation. A simulation result is shown in FIG. 3, and a reflectivity R1 of the anti-reflectance film 20B is 0.002%.

In this embodiment, the transition layer 23 includes following components in parts by weight: 40-70 parts of photopolymerization resin, 0-30 parts of photopolymerization monomer, 1-10 parts of photoinitiator, 5-30 parts of nano oxide dispersion, 900-9900 parts of solvent, and 0.1-1 part of other auxiliaries.

In this embodiment, a functionality of the photopolymerized resin is greater than or equal to 5, and the photopolymerized resin includes, but is not limited to, one or combinations of polyester acrylic resin, polyurethane acrylic resin, epoxy acrylic resin, or polysilsesquioxane. In an embodiment, the photopolymerized resin is the polyester acrylic resin. It may be understood that, incorporating FIG. 1, in the existing display module, the refractive index of the material of the anti-reflectance layer 22 is lower, and mechanical properties of the anti-reflectance layer 22 are worse. In this embodiment, the functionality of the polyester acrylic resin is greater than or equal to 5, so that the polyester acrylic resin has a fast curing rate and a high crosslinking density, thereby improving the mechanical properties of the transition layer 23, and solving problems of poor stability and low reliability of the conventional anti-reflectance film 20.

In this embodiment, a glass transition temperature of the photopolymerization monomer is greater than or equal to 85 degrees Celsius. It may be understood that, in this embodiment, the glass transition temperature of the photopolymerization monomer is greater than or equal to 85 degrees Celsius, so that an acting force between molecular segments is increased, a rigidity of the photopolymerization monomer is improved, and mechanical properties of the photopolymerization monomer are improved. Furthermore, the photopolymerization monomer includes a ring structure, the photopolymerization monomer includes, but is not limited to, one or combinations of isobornyl acrylate, isobornyl methacrylate, and tricyclodecane dimethanol diacrylate. In an embodiment, the photopolymerization monomer is the isobornyl acrylate with a bridge ring structure, the isobornyl acrylate has a larger rigidity, thereby further improving the mechanical properties of the transition layer 23.

In this embodiment, the nano oxide dispersion includes a plurality of nano-particles, the nano-particles include, but are not limited to, one or combinations of antimony pentoxide, zirconia, zinc oxide, titanium oxide, cerium oxide, and iridium oxide. A particle size of each of the plurality of nano-particles is greater than or equal to 5 nm, and less than or equal to 25 nm. In an embodiment, the nano-particles are zirconia (inorganic oxide with high refractive index). The nano-particles dispersed in the nano oxide dispersion, so that the nano oxide dispersion has high transparency, high refractive index, and low viscosity. It may be understood that the transition layer 23 with high refractive index is obtained by controlling types and sizes of the nano particles.

In this embodiment, a boiling point of the solvent is greater than or equal to 50 degrees Celsius, and less than or equal to 150 degrees Celsius. The solvent includes, but is not limited to, one or combinations of ethyl acetate, butyl acetate, propylene glycol monomethyl ether acetate, isopropanol, butanone, and cyclohexanone. It may be understood that, in this embodiment, the boiling point of the solvent is greater than or equal to 50 degrees Celsius, thereby preventing influence on a curing of the photopolymerized resin and the thickness of the transition layer 23, and preventing health hazards to production operators and environmental pollution at the same time. Furthermore, the boiling point of the solvent is greater than or equal to 50 degrees Celsius, so that difficulties of manufacturing the transition layer 23 in a drying process are reduced, and production efficiency is improved.

It should be noted that in this embodiment, selections of the photoinitiator are not specifically limited, as long as a maximum absorption wavelength of the photoinitiator matches an emission spectrum of an ultraviolet (UV) light source. In an embodiment, the photoinitiator includes, but is not limited to, one or combinations of biphenyl ketals, a, α-dialkyloxyphenyl acetones, α-hydroxyalkylbenzones, and acyl phosphine oxide.

Furthermore, in this embodiment, the other auxiliaries include, but is not limited to, any one or a mixture of antioxidants, leveling agents, adhesion promoters, initiators, wetting agents, defoamers, light stabilizers, polymerization inhibitors, and antistatic agents.

It should be noted that in another embodiment, the transition layer 23 and the anti-reflectance layer 22 may be sequentially coated on the substrate 21 by wet coating. The transition layer 23 includes following components in parts by weight: 40-70 parts of the photopolymerization resin, 0-30 parts of the photopolymerization monomer, 1-10 parts of the photoinitiator, 5-30 parts of the nano oxide dispersion, 900-9900 parts of the solvent, and 0.1-1 part of the other auxiliaries. The photopolymerization resin is the polyester acrylic resin having the functionality greater than or equal to 5. The photopolymerization monomer is the isobornyl acrylate with the bridge ring structure. The maximum absorption wavelength of the photoinitiator matches the emission spectrum of the ultraviolet light source. The nano oxide dispersion includes the plurality of nano-particles. The boiling point of the solvent is greater than or equal to 50 degrees Celsius, and less than or equal to 150 degrees Celsius. An interlayer adhesion and crosslinking density between the transition layer 23 and the anti-reflectance layer 22 are enhanced, thereby enhancing a scratch resistance of the anti-reflectance film 20B and achieving the better antireflection effect. At the same time, process difficulties of manufacturing the transition layer 23 in the embodiment are reduced, and the mechanical properties of the surface of the anti-reflectance layer 22 are improved.

### Embodiment 2

Incorporating FIG. 2 and FIG. 4, FIG. 4 is a curve diagram of reflectivity of an anti-reflectance film provided by an embodiment 2 of the present application under different wavelengths of the light.

In this embodiment, a structure of a display module is similar/identical to the structure of the display module provided in the above-mentioned embodiment. Please refer to descriptions of the display module in the above-mentioned embodiment for details, which will not be repeated herein. Differences between the structure of display module in this embodiment and the structure of the display module in above-mentioned embodiment are merely as follows.

In this embodiment, technical solutions of the present application are illustrated by taking following conditions as examples: The refractive index n₃ of the substrate 21 is 1.49, the material of the substrate 21 is the Triacetyl cellulose (TAC), the thickness D1 of the transition layer 23 is 30 μm, the refractive index n of the anti-reflectance layer 22 is 1.26, the thickness D2 of the anti-reflectance layer 22 is 109 nm, and the material of the anti-reflectance layer 22 is the silicon dioxide (SiO₂) of hollow particles. Furthermore, In this embodiment, under the conditions that the wavelength of the light λ is 550 nm, the optical film design software is used for simulation. A simulation result is shown in FIG. 4, and a reflectivity R2 of the anti-reflectance film 20B is 0.001%.

### Embodiment 3

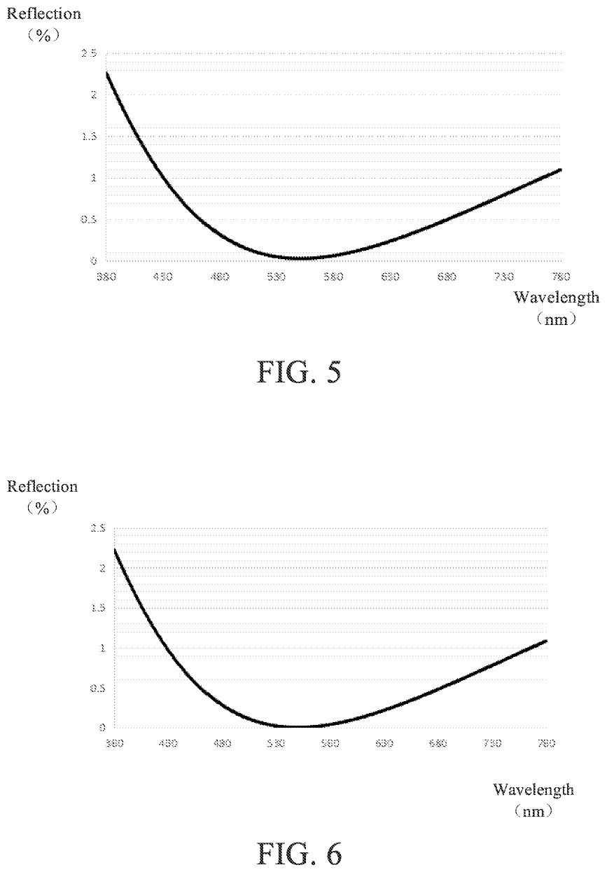

Incorporating FIG. 2 and FIG. 5, FIG. 5 is a curve diagram of reflectivity of an anti-reflectance film provided by an embodiment 3 of the present application under different wavelengths of the light.

In this embodiment, a structure of a display module is similar/identical to the structure of the display module provided in the above-mentioned embodiments. Please refer to descriptions of the display module in the above-mentioned embodiment for details, which will not be repeated herein. Differences between the structure of display module in this embodiment and the structure of the display module in above-mentioned embodiments are merely as follows.

In this embodiment, the technical solutions of the present application are illustrated by taking following conditions as examples: The refractive index n₃ of the substrate 21 is 1.49, the material of the substrate 21 is the Triacetyl cellulose (TAC), the refractive index n₂ of the transition layer 23 is 1.53, the thickness D1 of the transition layer 23 is 30 μm, the refractive index n₁ of the anti-reflectance layer 22 is 1.24, the thickness D2 of the anti-reflectance layer 22 is 111 nm, and the material of the anti-reflectance layer 22 is the silicon dioxide (SiO₂) of hollow particles. Furthermore, in this embodiment, under the conditions that the wavelength of the light λ is 550 nm, the optical film design software is used for simulation. A simulation result is shown in FIG. 5, and a reflectivity R3 of the anti-reflectance film 20B is 0.003%.

### Comparative Embodiment 1

Incorporating FIG. 1, FIG. 6, and Table 1, FIG. 6 is a curve diagram of reflectivity of an anti-reflectance film provided by a comparative embodiment 1 of the present application under different wavelengths of the light. Table 1 shows technical parameters and test results of the anti-reflectance film provided by the embodiment of the present application and the anti-reflectance film provided by the comparative embodiment 1.

TABLE 1

| | | | | refractive | thickness | refractive | thickness of | |
|---|---|---|---|---|---|---|---|---|
| | | refractive | material of the | index of the | of the anti- | index of the | thetransition | |
| | material of | index of the | anti-reflectance | anti-reflectance | reflectance film | transition | layer | reflectivity |
| | the substrate | substrate | film | film | (nm) | layer | (um) | (%) |
| embodiment 1 | Triacetyl | 1.49 | hollow silicon dioxide | 1.28 | 107 | 1.65 | 30 | 0.002% |
| | cellulose (TAC) | | (SiO₂) particles | | | | | |
| embodiment 2 | Triacetyl | 1.49 | hollow silicon dioxide | 1.26 | 109 | 1.59 | 30 | 0.001% |
| | cellulose (TAC) | | (SiO₂) particles | | | | | |
| embodiment 3 | Triacetyl | 1.49 | hollow silicon dioxide | 1.24 | 111 | 1.53 | 30 | 0.03% |
| | cellulose (TAC) | | (SiO₂) particles | | | | | |
| comparative | Triacetyl | 1.49 | hollow silicon dioxide | 1.22 | 110 | | | 0.006% |
| embodiment 1 | cellulose (TAC) | | (SiO₂) particles | | | | | |

The comparative embodiment 1 are illustrated by taking following conditions as examples: The refractive index n₃ of the substrate 21 is 1.49, the material of the substrate 21 is the Triacetyl cellulose (TAC), the refractive index n₁ of the anti-reflectance layer 22 is 1.22, the thickness D2 of the anti-reflectance layer 22 is 110 nm, and the material of the anti-reflectance layer 22 is the silicon dioxide (SiO₂) of hollow particles. Furthermore, In this embodiment, under the conditions that the wavelength of the light λ is 550 nm, the optical film design software is used for simulation. A simulation result is shown in FIG. 6 and Table 1, and a reflectivity R4 of the anti-reflectance film 20B is 0.006%.

It may be understood that in this embodiment, compare with the reflectivity R4 of the anti-reflectance film 20B in the comparative embodiment 1, the reflectivity R1 of the anti-reflectance film 20B in the embodiment 1 and the reflectivity R2 of the anti-reflectance film 20B in the embodiment 2 are both significantly reduced in a vicinity of the wavelength of 550 nm, thereby improving the display effect of the display panel 10. Compare with the reflectivity R4 of the anti-reflectance film 20B in the comparative embodiment 1, the reflectivity R3 of the anti-reflectance film 20B in the embodiment 3 are significantly improved in the vicinity of the wavelength of 550 nm. Therefore, when the refractive index n₂ of the transition layer 23 is greater than or equal to 1.56, and less than or equal to 1.65, the antireflection effect of the anti-reflectance film 20B is improved. When the refractive index n₂ of the transition layer 23 is less than 1.56, the antireflection effect of the anti-reflectance film 20B is reduced.

Therefore, in this embodiment, the refractive index n₂ of the transition layer 23 is greater than or equal to 1.56, and less than or equal to 1.65. The refractive index n₁ of the anti-reflectance layer 22 is greater than or equal to 1.25, and less than or equal to 1.28. Compare with the conventional anti-reflectance film 20, the anti-reflectance layer 22 provided by the embodiment of the present application has higher refractive index, thereby reducing the difficulties of manufacturing processes of the anti-reflectance layer 22 in the embodiments of the present application, improving the mechanical properties of the surface of the anti-reflectance layer 22, and improving the display effects of the display panel 10 without affecting other performances of the display panel 10 at the same time.

The embodiment provides a display device, the display device includes the display panel and the anti-reflectance film 20B described in any one of the above-mentioned embodiments. The anti-reflectance film 20B is located on the light-emitting side of the display panel.

The display panel includes, but is not limited to, one of a LED (Light emitting diode) display panel, an OLED (Organic light emitting diode) display panel, or a LCD (Liquid crystal display) panel. When the display panel is the LED display panel, the display panel includes, but is not limited to, one of a Mini LED and Micro LED, the embodiment does not specifically limit this.

It may be understood that the anti-reflectance film 20B has been described in detail in the above-described embodiments and will not be repeated here.

In specific applications, the display device may be display screens of smart phones, tablet computers, notebook computers, smart bracelets, smart watches, smart glasses, smart helmets, desktop computers, smart televisions, digital cameras, and other devices. The display device may even be applied to electronic devices with flexible display screens.

In summary, the present application provides the anti-reflectance film and the display device. The display device includes the display panel and the anti-reflectance film located on the light-emitting side of the display panel. The anti-reflectance film may prevent total reflection of ambient light on the display panel, thereby reducing the reflectivity of the display panel. The anti-reflectance film includes the substrate, the transition layer, and the anti-reflectance layer. The transition layer is located on the side of the substrate. The anti-reflectance layer is located on the side of the transition layer away from the substrate. The refractive index of the transition layer is greater than the refractive index of the substrate. Compare with the conventional anti-reflectance film, in the embodiments, the refractive index of the transition layer is greater than the refractive index of the substrate, so that the anti-reflectance layer has higher refractive index, thereby reducing the process difficulties of manufacturing the anti-reflectance layer in the embodiments of the present application, improving the mechanical properties of the surface of the anti-reflectance layer, and improving the display effects of the display panel without affecting other performances of the display panel at the same time.

In the above-mentioned embodiments, descriptions of each embodiment have their own emphasis, for parts not detailed in one embodiment, please refer to relevant descriptions of other embodiments.

The anti-reflectance film and the display device provided in the embodiments of the present application are described in detail above. The principle and implementations of the present application are described in this specification by using specific examples. The description about the foregoing embodiments is merely provided to help understand the method and core ideas of the present application. Persons of ordinary skill in the art should understand that they may still make modifications to the technical solutions described in the foregoing embodiments or make equivalent replacements to some or all technical features thereof, without departing from the scope of the technical solutions of the embodiments of the present application.

What is claimed is:

1. An anti-reflectance film, comprising:
a substrate;
a transition layer located on a side of the substrate; and
an anti-reflectance layer located on a side of the transition layer away from the substrate;
wherein a refractive index of the transition layer is greater than a refractive index of the substrate.

2. The anti-reflectance film according to claim 1, wherein a refractive index of the anti-reflectance layer and the refractive index of the transition layer satisfy a following relationship:
n₁²=n₀×n₂;
wherein, n₀ denotes a refractive index of an external medium located on a side of the anti-reflectance layer away from the transition layer, n₁ denotes the refractive index of the anti-reflectance layer, and n₂ denotes the refractive index of the transition layer.

3. The anti-reflectance film according to claim 2, wherein the refractive index of the transition layer is greater than or equal to 1.56, and less than or equal to 1.65, and the refractive index of the anti-reflectance layer is greater than or equal to 1.25, and less than or equal to 1.28.

4. The anti-reflectance film according to claim 1, wherein a thickness of the transition layer and the refractive index of the transition layer satisfy a following relationship:
$${D}_{1} = \frac{( m + 1 / 2 )}{\begin{matrix}( λ / 2 ) & {n}_{2}\end{matrix}} ;$$
wherein, n₂ denotes the refractive index of the transition layer, λ is a wavelength of light, m is a natural number, and D1 denotes the thickness of the transition layer.

5. The anti-reflectance film according to claim 4, wherein the thickness of the transition layer is greater than or equal to 30 μm, and less than or equal to 110 μm.

6. The anti-reflectance film according to claim 1, wherein the transition layer comprises following components in parts by weight: 40-70 parts of photopolymerization resin, 0-30 parts of photopolymerization monomer, 1-10 parts of photoinitiator, 5-30 parts of nano oxide dispersion, 900-9900 parts of solvent, and 0.1-1 part of other auxiliaries.

7. The anti-reflectance film according to claim 6, wherein a functionality of the photopolymerized resin is greater than or equal to 5, and the photopolymerized resin comprises one or combinations of polyester acrylic resin, polyurethane acrylic resin, epoxy acrylic resin, and polysilsesquioxane.

8. The anti-reflectance film according to claim 6, wherein a glass transition temperature of the photopolymerization monomer is greater than or equal to 85 degrees Celsius.

9. The anti-reflectance film according to claim 8, wherein the photopolymerization monomer comprises a ring structure, the photopolymerization monomer comprises one or combinations of isobornyl acrylate, isobornyl methacrylate, and tricyclodecane dimethanol diacrylate.

10. The anti-reflectance film according to claim 6, wherein the nano oxide dispersion comprises a plurality of nano-particles, the nano-particles comprise but are not limited to one or combinations of antimony pentoxide, zirconia, zinc oxide, titanium oxide, cerium oxide, and iridium oxide, and a particle size of each of the plurality of nano-particles is greater than or equal to 5 nm, and less than or equal to 25 nm.

11. The anti-reflectance film according to claim 6, wherein a boiling point of the solvent is greater than or equal to 50 degrees Celsius, and less than or equal to 150 degrees Celsius.

12. A display device, comprising a display panel and an anti-reflectance film, wherein the anti-reflectance film is located on a light-emitting side of the display panel; the anti-reflectance film comprises:
a substrate;
a transition layer located on a side of the substrate; and
an anti-reflectance layer located on a side of the transition layer away from the substrate;
wherein a refractive index of the transition layer is greater than a refractive index of the substrate.

13. The display device according to claim 12, wherein the refractive index of the anti-reflectance layer and the refractive index of the transition layer satisfy a following relationship:
n₁²=n₀×n₂;
wherein, n₀ denotes a refractive index of an external medium located on a side of the anti-reflectance layer away from the transition layer, n₁ denotes the refractive index of the anti-reflectance layer, and n₂ denotes the refractive index of the transition layer.

14. The display device according to claim 13, wherein the refractive index of the transition layer is greater than or equal to 1.56, and less than or equal to 1.65, and the refractive index of the anti-reflectance layer is greater than or equal to 1.25, and less than or equal to 1.28.

15. The display device according to claim 12, wherein a thickness of the transition layer and the refractive index of the transition layer satisfy a following relationship:
$${D}_{1} = \frac{( m + 1 / 2 )}{\begin{matrix}( λ / 2 ) & {n}_{2}\end{matrix}} ;$$
wherein, n₂ denotes the refractive index of the transition layer, λ is a wavelength of light, m is a natural number, and D1 denotes the thickness of the transition layer.

16. The display device according to claim 15, wherein the thickness of the transition layer is greater than or equal to 30 μm, and less than or equal to 110 μm.

17. The display device according to claim 12, wherein the transition layer comprises following components in parts by weight: 40-70 parts of photopolymerization resin, 0-30 parts of photopolymerization monomer, 1-10 parts of photoinitiator, 5-30 parts of nano oxide dispersion, 900-9900 parts of solvent, and 0.1-1 part of other auxiliaries.

18. The display device according to claim 17, wherein a functionality of the photopolymerized resin is greater than or equal to 5, and the photopolymerized resin comprises one or combinations of polyester acrylic resin, polyurethane acrylic resin, epoxy acrylic resin, and polysilsesquioxane.

19. The display device according to claim 17, wherein a glass transition temperature of the photopolymerization monomer is greater than or equal to 85 degrees Celsius.

20. The display device according to claim 19, wherein the photopolymerization monomer comprises a ring structure, the photopolymerization monomer comprises one or combinations of isobornyl acrylate, isobornyl methacrylate, and tricyclodecane dimethanol diacrylate.
